(19) United States
(12) Patent Application Publication
(10) Pub. No.: US 2026/0092808 A1
(43) Pub. Date: Apr. 2, 2026

(54) ESTIMATION APPARATUS, ESTIMATION METHOD AND PROGRAM

(71) Applicant: NTT, Inc., Tokyo (JP)

(72) Inventors: Takeo SASAI, Musashino-shi (JP); Etsushi YAMAZAKI, Musashino-shi (JP); Hideki NISHIZAWA, Musashino-shi (JP); Yoshiaki SONE, Musashino-shi (JP); Yoshiaki KISAKA, Musashino-shi (JP)

(73) Assignee: NTT, Inc., Tokyo (JP)

(21) Appl. No.: 19/110,998

(22) PCT Filed: Sep. 27, 2022
(86) PCT No.: PCT/JP2022/035896

§ 371 Date: Mar. 12, 2025

(51) Int. Cl. G01H 9/00

(52) U.S. Cl. CPC G01H 9/004

(57) ABSTRACT

An aspect of the present invention is an estimation device including: a control unit that estimates a vibration position that is a position on an optical fiber where vibration is induced by vibration of an external environment based on a reception signal that is a result of propagation of a transmission signal that is an optical signal transmitted by a transmitter through the optical fiber, in which the control unit executes estimation processing including: compensation processing including wavelength dispersion compensation processing of compensating for wavelength dispersion with respect to the reception signal, transmission signal estimation processing of estimating the transmission signal based on a result of the wavelength dispersion compensation processing, wavelength dispersion reapplication processing of reapplying the wavelength dispersion to a result of the compensation processing, and vibration position estimation processing of estimating the vibration position based on a result of inverse mapping of mapping according to the vibration position, the mapping representing a change in the transmission signal due to propagation through the optical fiber, acting on a result of the wavelength dispersion reapplication processing and a result of the transmission signal estimation processing.

### TECHNICAL FIELD

The present invention relates to an estimation device, an estimation method, and a program.

### BACKGROUND ART

A sensing technology for estimating a position on an optical fiber where vibration is induced by vibration of an external environment, which is an environment outside the optical fiber, using optical fibers running around various places as a result of an increase in demand for optical communication has been studied. The vibration of the external environment is, for example, an earthquake. The position to be estimated is a position on the optical fiber, but since the position vibrates due to vibration of the external environment in contact with the position, the result of the estimation indicates the position of vibration of the external environment.

### CITATION LIST

### Non Patent Literature

Non Patent Literature 1: Ezra Ip, et al., “Distributed fiber sensor network using telecom cables as sensing media: technology advancements and applications [Invited]” Vol. 14, No. 1/January 2022/Journal of Optical Communications and Networking A61-A68
Non Patent Literature 2: Alan Pak Tao Lau, et al., “Equalization-enhanced phase noise for 100 Gb/s transmission and beyond with coherent detection” 2 Aug. 2010/Vol. 18, No. 16/OPTICS EXPRESS 17239
Non Patent Literature 3: Aditya Kakkar, “Comprehensive Study of Equalization-Enhanced Phase Noise in Coherent Optical Systems” JOURNAL OF LIGHTWAVE TECHNOLOGY, VOL. 33, NO. 23, Dec. 1, 2015, p. 4834-4841

### SUMMARY OF INVENTION

### Technical Problem

When an existing optical fiber for optical communication is caused to have a sensing function, it is desirable to minimize the effect on an optical communication system that is already commercially operated. However, in the technologies proposed so far, dedicated light for estimating the position of vibration needs to be incident on an optical fiber while occupying a certain frequency band, and therefore, there is a problem that the frequency utilization efficiency of the optical communication system is reduced, and the signal quality of a communication channel propagating in another frequency band is reduced due to a nonlinear optical effect.

In view of the above circumstances, an object of the present invention is to provide a technique for estimating a vibration position without causing a reduction in frequency utilization efficiency of an optical communication system and signal deterioration of another communication channel in estimating a position on an optical fiber where vibration is induced by vibration of an external environment using an optical fiber for optical communication.

### Solution to Problem

An aspect of the present invention is an estimation device including: a control unit that estimates a vibration position that is a position on an optical fiber where vibration is induced by vibration of an external environment based on a reception signal that is a result of propagation of a transmission signal that is an optical signal transmitted by a transmitter through the optical fiber, in which the control unit executes estimation processing including: compensation processing including wavelength dispersion compensation processing of compensating for wavelength dispersion with respect to the reception signal, transmission signal estimation processing of estimating the transmission signal based on a result of the wavelength dispersion compensation processing, wavelength dispersion reapplication processing of reapplying the wavelength dispersion to a result of the compensation processing, and vibration position estimation processing of estimating the vibration position based on a result of inverse mapping of mapping according to the vibration position, the mapping representing a change in the transmission signal due to propagation through the optical fiber, acting on a result of the wavelength dispersion reapplication processing and a result of the transmission signal estimation processing.

An aspect of the present invention is an estimation method including: a control step of estimating a vibration position that is a position on an optical fiber where vibration is induced by vibration of an external environment based on a reception signal that is a result of propagation of a transmission signal that is an optical signal transmitted by a transmitter through the optical fiber, in which the control step executes estimation processing including: compensation processing including wavelength dispersion compensation processing of compensating for wavelength dispersion with respect to the reception signal, transmission signal estimation processing of estimating the transmission signal based on a result of the wavelength dispersion compensation processing, wavelength dispersion reapplication processing of reapplying the wavelength dispersion to a result of the compensation processing, and vibration position estimation processing of estimating the vibration position based on a result of inverse mapping of mapping according to the vibration position, the mapping representing a change in the transmission signal due to propagation through the optical fiber, acting on a result of the wavelength dispersion reapplication processing and a result of the transmission signal estimation processing.

An aspect of the present invention is a program for causing a computer to function as the estimation device.

### Advantageous Effects of Invention

According to the present invention, it is possible to estimate a vibration position without causing a reduction in frequency utilization efficiency of an optical communication system and signal deterioration of another communication channel in estimating a position on an optical fiber where vibration is induced by vibration of an external environment using an optical fiber for optical communication.

### BRIEF DESCRIPTION OF DRAWINGS

FIG. 1 is a diagram illustrating an example of a configuration of an estimation system of an embodiment.

FIG. 2 is an explanatory diagram describing an example of a process in which a waveform of an optical signal propagating through an optical fiber is deformed according to the embodiment.

FIG. 3 is a flowchart illustrating an example of a flow of estimation processing according to the embodiment.

FIG. 4 is a flowchart illustrating an example of a flow of compensation processing according to the embodiment.

FIG. 5 is a flowchart illustrating an example of a flow of transmission signal estimation processing according to the embodiment.

FIG. 6 is a flowchart illustrating a first example of a flow of vibration position estimation processing according to the embodiment.

FIG. 7 is a flowchart illustrating a second example of a flow of vibration position estimation processing according to the embodiment.

### DESCRIPTION OF EMBODIMENTS

### Embodiment

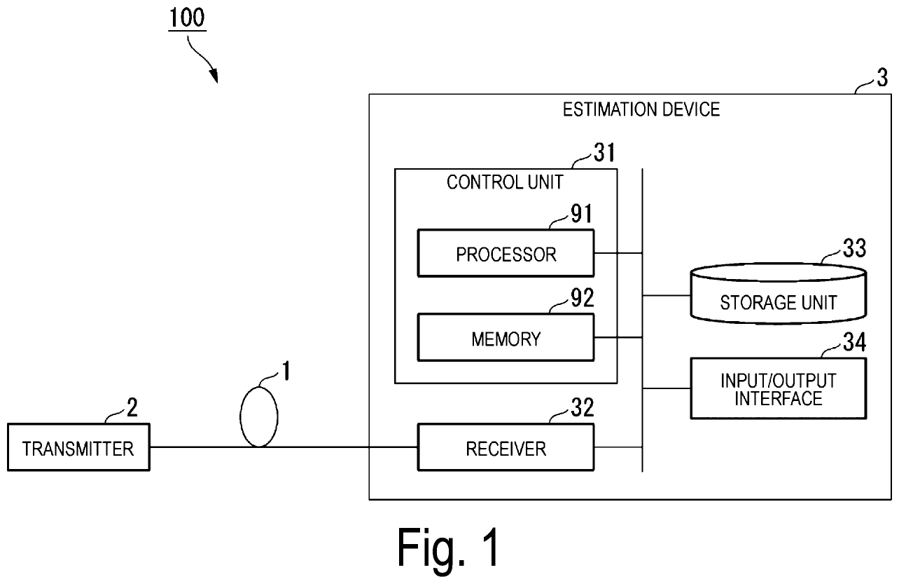

FIG. 1 is a diagram illustrating an example of a configuration of an estimation system 100 of an embodiment. The estimation system 100 includes an optical fiber 1, and estimates a vibration position that is a position on the optical fiber 1 where vibration is induced by vibration of an external environment. Note that the external environment means an environment external to the optical fiber 1. The optical fiber 1 is an optical fiber that propagates an incident optical signal. The vibration of the external environment is, for example, an earthquake.

The estimation system 100 further includes a transmitter 2 and an estimation device 3. The transmitter 2 transmits an optical signal. An optical signal transmitted by the transmitter 2 (hereinafter referred to as a “transmission signal”) is incident on the optical fiber 1.

The estimation device 3 receives the optical signal propagated through the optical fiber 1. That is, the estimation device 3 receives a reception signal that is a result of the transmission signal propagating through the optical fiber 1. The estimation device 3 estimates the vibration position on the basis of the reception signal.

The optical fiber 1, the transmitter 2, and the estimation device 3 are also used for optical communication. Accordingly, the transmission signal propagates through the optical fiber 1 and reaches the estimation device 3, and is decoded by the estimation device 3, so that information transmitted from the transmitter 2 to the estimation device 3 is sent to the estimation device 3.

The waveform of the transmission signal is deformed during propagation through the optical fiber 1. The deformation is caused, for example, by wavelength dispersion. The deformation is caused, for example, by phase noise applied to the optical signal by vibration at the vibration position.

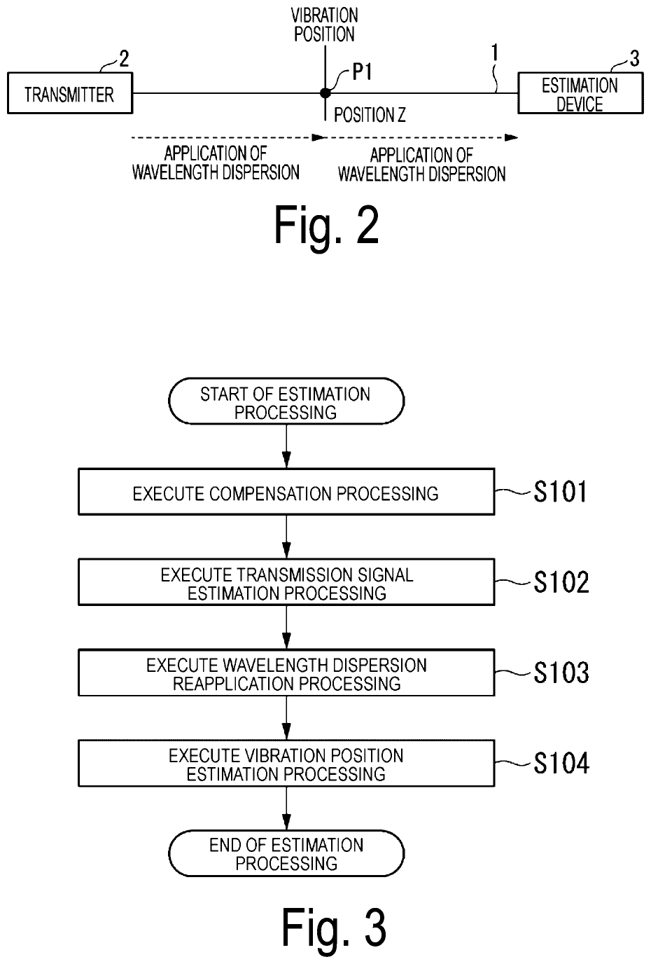

FIG. 2 is an explanatory diagram describing an example of a process in which a waveform of an optical signal propagating through the optical fiber 1 is deformed according to the embodiment. More specifically, FIG. 2 is an explanatory diagram describing wavelength dispersion or noise applied to a transmission signal propagating through the optical fiber 1 from the transmitter 2 to the estimation device 3. The transmission signal emitted from the transmitter 2 propagates to a position Z on the optical fiber 1 indicated by a point P1 in FIG. 2, and wavelength dispersion is applied during the propagation. The point P1 is a position on the optical fiber 1 and is a vibration position.

Since the position Z is a vibration position, a phase noise is further applied to the transmission signal at the position Z. Thereafter, the transmission signal propagates to the estimation device 3. Wavelength dispersion is applied to the transmission signal during the propagation. In this manner, the waveform of the transmission signal propagating through the optical fiber 1 changes from the waveform when the transmitter 2 performs emission. The estimation device 3 estimates the position where the phase noise related to the transmission signal is applied in this manner on the basis of the reception signal.

The description returns to FIG. 1. The estimation device 3 includes a control unit 31 including a processor 91 such as a central processing unit (CPU) and a memory 92 connected by a bus, and executes a program. The estimation device 3 functions as a device including the control unit 31, a receiver 32, a storage unit 33, and an input/output interface 34 by executing programs.

More specifically, the processor 91 reads out programs stored in the storage unit 33 and stores the readout programs in the memory 92. The processor 91 executes the programs stored in the memory 92, whereby the estimation device 3 functions as a device including the control unit 31, the receiver 32, the storage unit 33, and the input/output interface 34.

The control unit 31 controls operations of various functional units included in the estimation device 3. The control unit 31 executes, for example, estimation processing. The estimation processing includes compensation processing, transmission signal estimation processing, wavelength dispersion reapplication processing, and vibration position estimation processing. The compensation processing is processing including wavelength dispersion compensation processing. The wavelength dispersion compensation processing is processing of compensating for wavelength dispersion with respect to a reception signal. The transmission signal estimation processing is processing of estimating a transmission signal on the basis of a result of the wavelength dispersion compensation processing. The wavelength dispersion compensation processing and the transmission signal estimation processing are processing executed also in optical communication.

The wavelength dispersion reapplication processing is processing of reapplying the wavelength dispersion to a result of the compensation processing. The vibration position estimation processing is processing of estimating the vibration position based on the result of inverse mapping of propagation mapping acting on the result of the wavelength dispersion reapplication processing and the result of the transmission signal estimation processing. The propagation mapping is mapping according to the vibration position, and is mapping representing a change in the transmission signal due to propagation through the optical fiber 1. Accordingly, the inverse mapping of the propagation mapping is mapping representing an inverse event of the event in which the transmission signal propagates through the optical fiber 1 from the transmitter 2 to the receiver 32, that is, an event in which the reception signal propagates back from the receiver 32 to the transmitter 2.

### <Technical Significance of Purposely Applying Wavelength Dispersion>

Here, the technical significance of purposely applying the wavelength dispersion will be described. That is, the technical significance of the wavelength dispersion reapplication processing will be described. In general, the optical signal propagated through the optical fiber 1 has a waveform deformation due to wavelength dispersion and a waveform deformation due to phase noise. In optical communication, wavelength dispersion is compensated by executing wavelength dispersion compensation processing. In general, when wavelength dispersion compensation is performed, phase noise changes to equalization-enhanced phase noise (EEPN). Therefore, when wavelength dispersion compensation is executed, it becomes difficult to estimate phase noise.

However, the estimation device 3 estimates the position where the phase noise is applied. Therefore, the control unit 31 purposely reapplies the wavelength dispersion to the result of the wavelength dispersion compensation processing executed also in the existing optical communication so as to use an existing device used in the optical communication. In this way, the control unit 31 can return the EEPN to the phase noise before the wavelength dispersion is given.

The receiver 32 receives the reception signal. The storage unit 33 is configured using a computer-readable storage medium device (non-transitory computer-readable recording medium) such as a magnetic hard disk device or a semiconductor storage device. The storage unit 33 stores various types of information related to the estimation device 3. The storage unit 33 stores, for example, a result of processing executed by the control unit 31. Accordingly, the storage unit 33 stores, for example, a result of the estimation processing.

The input/output interface 34 inputs and outputs various types of information. The input/output interface 34 is configured to include a display device as an interface for outputting information such as a cathode ray tube (CRT) display, a liquid crystal display, or an organic electro-luminescence (EL) display. The interface for outputting information may be configured as an interface that connects these display devices to the estimation device 3.

The input/output interface 34 is configured as an interface that receives input of information, for example, an interface that connects an input device such as a mouse, a keyboard, or a touch panel to the estimation device 3. The interface that receives input of information may be configured to include these input devices. The input/output interface 34 outputs, for example, a result of processing executed by the control unit 31. Accordingly, the input/output interface 34 outputs, for example, a result of the estimation processing.

FIG. 3 is a flowchart illustrating an example of a flow of estimation processing according to the embodiment. The control unit 31 executes the compensation processing (step S101). Next, the control unit 31 executes the transmission signal estimation processing (step S102). Next, the control unit 31 executes the wavelength dispersion reapplication processing (step S103). Next, the control unit 31 executes the vibration position estimation processing (step S104).

Note that the processing in step S102 may be executed at any timing after the execution of the processing in step S101 and before the execution of the processing in step S104.

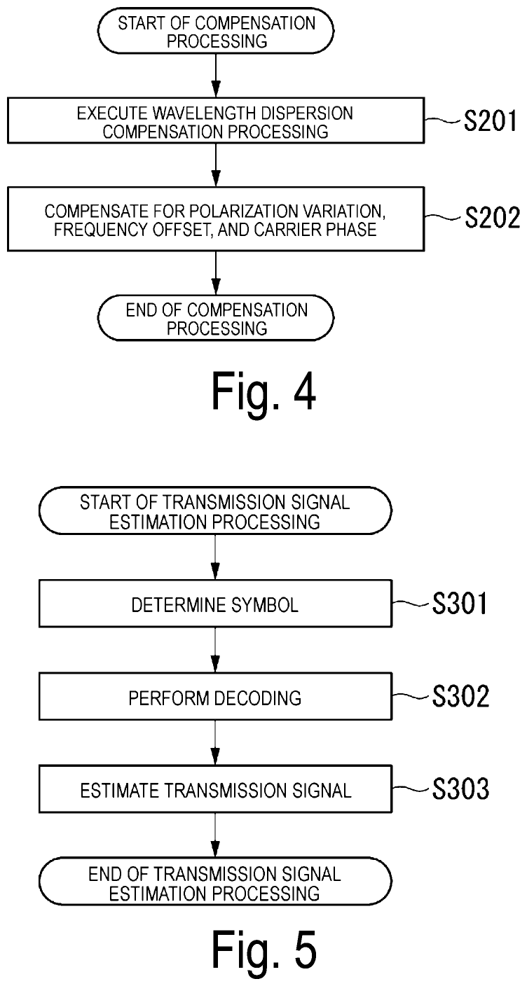

FIG. 4 is a flowchart illustrating an example of a flow of compensation processing according to the embodiment. The control unit 31 executes the wavelength dispersion compensation processing (step S201). Next, the control unit 31 compensates for a polarization variation, a frequency offset, and a carrier phase with respect to the result of the wavelength dispersion compensation processing (step S202).

FIG. 5 is a flowchart illustrating an example of a flow of transmission signal estimation processing according to the embodiment. The control unit 31 determines a symbol of a determination target using the result of the compensation processing as a determination target (step S301). Next, the control unit 31 decodes the content indicated by the result of step S301 (step S302). Next, the control unit 31 estimates the transmission signal on the basis of the result of step S302 (step S303).

In the estimation of the transmission signal in step S303, for example, remapping and processing of filtering using a Nyquist filter are executed with respect to the result of step S302. Remapping is processing of assigning information to the amplitude and phase of an optical wave. The processing of filtering using a Nyquist filter is processing of narrowing the spectral width of the wave as a result of remapping.

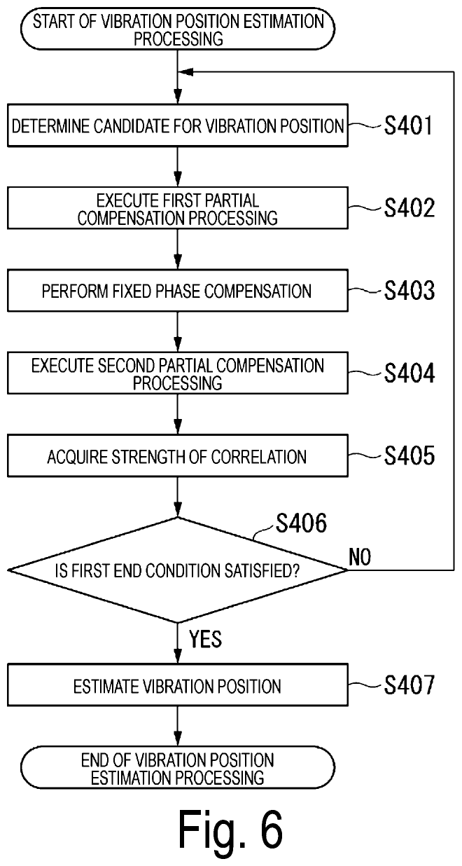

FIG. 6 is a flowchart illustrating a first example of a flow of vibration position estimation processing according to the embodiment. The control unit 31 determines candidates for vibration position according to a predetermined rule (step S401). Next, the control unit 31 executes a first partial compensation processing on a processing target as a result of the wavelength dispersion reapplication processing (step S402). The first partial compensation processing is processing of compensating for the wavelength dispersion applied to the optical signal and applied while the optical signal propagates from the receiver 32 to the candidate position determined in step S401 with respect to the processing target.

Next, the control unit 31 executes fixed phase compensation on the processing target as a result of the first partial compensation processing (step S403). The fixed phase compensation processing is processing of performing fixed phase compensation applied at the candidate position estimated in step S401 with respect to the processing target.

Formula (1) described below represents fixed phase compensation.

$$\begin{matrix}[ Math . 1 ] & \\ {u}_{out} = {u}_{in} \cdot exp ( - j ε ) & ( 1 )\end{matrix}$$

$$\begin{matrix}[ Math . 2 ] & \\ {u}_{in} = [ \begin{matrix}{u}_{in , x} \\ {u}_{in , y}\end{matrix} ] & ( 2 )\end{matrix}$$

$$\begin{matrix}[ Math . 3 ] & \\ {u}_{out} = [ \begin{matrix}{u}_{out , x} \\ {u}_{out , y}\end{matrix} ] & ( 3 )\end{matrix}$$

uₒᵤₜ represents a result of the fixed phase compensation. uᵢₙ represents a processing target before compensation by the fixed phase compensation. A phase ε compensated in the fixed phase compensation is a predetermined value the value of which is fixed regardless of measurement position candidate. Note that the phase E is an example of the value of the phase variation. Note that u_{out,x} means an x-polarization signal of the output of the present processing. u_{out,y} means a y-polarization signal of the output of the present processing. u_{in,x} means an x-polarization signal of the input of the present processing. u_{in,y} means a y-polarization signal of the input of the present processing. Note that exp(−jε) is an example of a function that approximates the phase variation. Note that j represents an imaginary unit.

Next, the control unit 31 executes second partial compensation processing on the processing target as a result of the fixed phase compensation (step S404). The second partial compensation processing is processing of compensating for the wavelength dispersion applied to the optical signal and applied while the optical signal propagates from the candidate position determined in step S401 to the transmitter 2 with respect to the processing target.

As described above, the series of processing of steps S402 to S404 is processing of estimating the result of the inverse event of the event in which the transmission signal propagates through the optical fiber 1 from the transmitter 2 to the receiver 32. Accordingly, the series of processing of steps S402 to S404 is an example of processing of obtaining a result of the inverse mapping of the propagation mapping acting on the result of the wavelength dispersion reapplication processing. Therefore, the result obtained in step S404 is an example of a result in which the inverse mapping of the propagation mapping acts on the result of the wavelength dispersion reapplication processing.

After step S404, the control unit 31 obtains the level of signal similarity on the basis of the result obtained in step S404 and the result of the transmission signal estimation processing (step S405). The signal similarity is a similarity between the result of the inverse mapping of the propagation mapping acting on the result of the wavelength dispersion reapplication processing and the result of the transmission signal estimation processing. Accordingly, in step S405, the signal similarity is a similarity between the result obtained in step S404 and the result of the transmission signal estimation processing. The level of similarity may be evaluated, for example, by correlation or may be evaluated by square error.

Next, the control unit 31 determines whether a predetermined end condition (hereinafter, referred to as a “first end condition”) related to the acquisition of the level of signal similarity is satisfied (step S406). The first end condition is, for example, a condition that the level of signal similarity is acquired for all vibration position candidates prepared in advance.

If the first end condition is not satisfied (step S406: NO), the processing returns to step S401. A predetermined rule in the processing of step S401 is, for example, a rule that a candidate for the vibration position is determined by excluding a candidate for which the vibration position has already been estimated.

On the other hand, if the first end condition is satisfied (step S406: YES), the control unit 31 estimates a candidate having the highest level of signal similarity among the candidates for the vibration position as the vibration position (step S407). That is, in the vibration position estimation processing, the position having the highest level of signal similarity is estimated as the vibration position.

For example, in this manner, the control unit 31 estimates the vibration position based on the result of the inverse mapping of the propagation mapping acting on the result of the wavelength dispersion reapplication processing and the result of the transmission signal estimation processing.

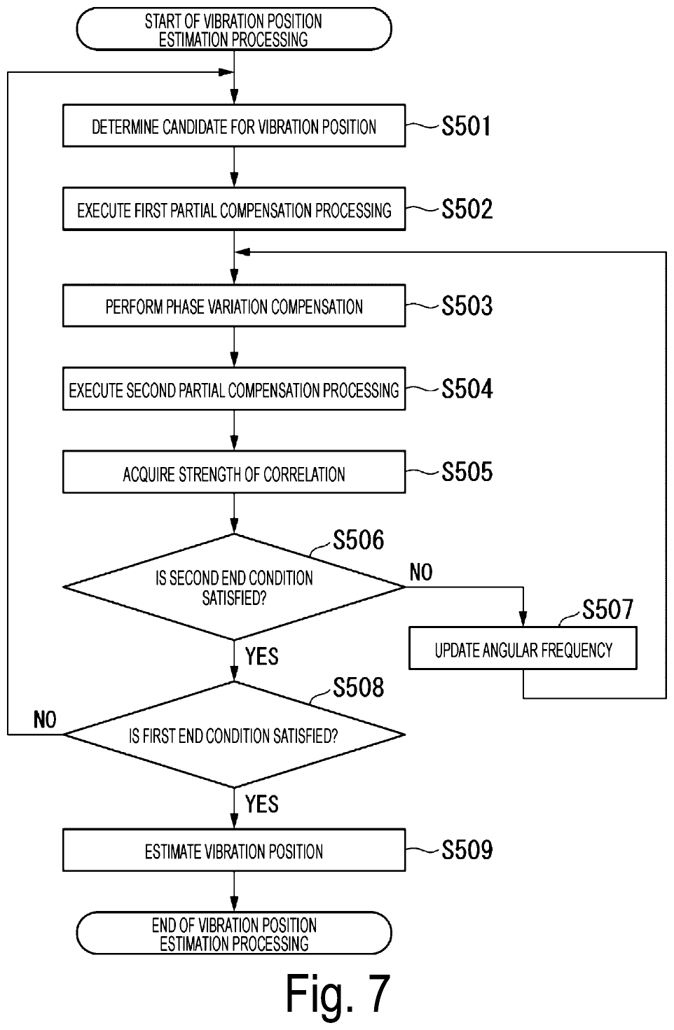

FIG. 7 is a flowchart illustrating a second example of a flow of vibration position estimation processing according to the embodiment. The control unit 31 determines candidates for vibration position according to a predetermined rule (step S501). Next, the control unit 31 executes the first partial compensation processing on the processing target as a result of the wavelength dispersion reapplication processing (step S502).

Next, the control unit 31 executes the phase variation compensation on the processing target as a result of the first partial compensation processing (step S503). The phase variation compensation is processing of performing phase noise compensation applied at the candidate position estimated in step S501 with respect to the processing target. The phase variation compensation is different from the fixed phase compensation in that an angular frequency ε of the phase variation is not fixed.

Next, the control unit 31 executes the second partial compensation processing on the processing target as a result of the phase variation compensation (step S504). Next, the control unit 31 obtains the level of signal similarity on the basis of the result obtained in step S504 and the result of the transmission signal estimation processing (step S505). In step S505, the signal similarity is a similarity between the result obtained in step S504 and the result of the transmission signal estimation processing. The level of similarity may be evaluated, for example, by correlation or may be evaluated by square error.

Next, the control unit 31 determines whether a predetermined condition (hereinafter, referred to as a “second end condition”) related to the optimization of the angular frequency ε of the phase variation is satisfied (step S506). The second end condition is, for example, a condition that the level of similarity obtained in step S505 is maximum. If the second end condition is not satisfied (step S506: NO), the control unit 31 updates the angular frequency ε of the phase variation according to a predetermined rule (step S507). The predetermined rule is, for example, a rule of updating the angular frequency E of the phase variation so as to increase the level of similarity obtained in step S505. Next, the processing returns to step S503. In step S503 to which the processing returns, the updated angular frequency ε is used.

On the other hand, if the second end condition is satisfied (step S506: YES), the control unit 31 determines whether the first end condition is satisfied (step S508). If the first end condition is not satisfied (step S508: NO), the processing returns to step S501. A predetermined rule in the processing of step S501 is, for example, a rule that a candidate for the vibration position is determined by excluding a candidate for which the vibration position has already been estimated.

On the other hand, if the first end condition is satisfied (step S508: YES), the control unit 31 estimates a candidate having the highest level of signal similarity among the candidates for the vibration position as the vibration position (step S509). That is, in the vibration position estimation processing, the position having the highest level of signal similarity is estimated as the vibration position.

For example, in this manner, the control unit 31 estimates the vibration position based on the result of the inverse mapping of the propagation mapping acting on the result of the wavelength dispersion reapplication processing and the result of the transmission signal estimation processing.

Note that, as described above, the second end condition may be a condition that the level of similarity obtained in step S504 is maximum (hereinafter referred to as “condition example”). Then, the predetermined rule in step S507 may be a rule (hereinafter referred to as an “rule example”) of updating the angular frequency ε of the phase variation so as to increase the level of similarity obtained in step S505. In such a case, the value of ε at the vibration position estimated in step S509 is a value that satisfies the condition for most removing the phase noise at the vibration position as compared with values of ε of the others.

Therefore, the vibration position estimation processing in the example of FIG. 7 in which the second end condition is the above-described condition example and the predetermined rule in step S507 is the above-described rule example is an example of processing of executing removal condition optimization processing on one or a plurality of candidates for the vibration position. The removal condition optimization processing is processing of estimating a condition for most removing the phase noise at the vibration position based on the result of the inverse mapping acting on the result of the wavelength dispersion reapplication processing and the result of the transmission signal estimation processing.

In addition, as described above, in the example of FIG. 7, the value of ε at the vibration position estimated in step S509 may be a value that satisfies the condition for most removing the phase noise at the vibration position as compared with values of ε of the others. Accordingly, in the estimation of the condition for most removing the phase noise at the vibration position, for example, the value of the angular frequency of the phase variation at the vibration position is estimated.

The estimation device 3 in the embodiment configured as described above estimates the vibration position based on the result of the inverse mapping of the propagation mapping acting on the result of the wavelength dispersion reapplication processing and the result of the transmission signal estimation processing. As a result, in the estimation of the vibration position using the estimation device 3, it is not necessary to cause dedicated light such as an optical pulse to be incident on the optical fiber for estimation, and the estimation can be performed only by performing signal analysis on a reception signal of a communication signal used in optical communication. Accordingly, since a part of a wavelength division multiplexing (WDM) channel of optical communication is not occupied, there is an effect that frequency utilization efficiency does not decrease and quality deterioration of an optical communication signal to another communication channel due to a nonlinear optical effect does not occur. That is, the estimation device 3 can estimate a vibration position without causing a reduction in frequency utilization efficiency of an optical communication system and signal deterioration of another communication channel in estimating a position on an optical fiber where vibration is induced by vibration of an external environment using an optical fiber for optical communication.

In addition, the estimation device 3 according to the embodiment configured as described above estimates the vibration position only by performing signal analysis on the reception signal of the communication signal. Therefore, it is not necessary to prepare an additional optical system for the optical communication system in order to estimate the vibration position, and there is also an effect that it is not necessary to change the configuration of the already installed optical communication system.

### Modification

Note that the control unit 31 may execute the estimation processing on a plurality of reception signals having different timings of propagation through the optical fiber 1. The result of such estimation processing is output from the input/output interface 34, for example. In such a case, the user of the estimation device 3 can obtain information indicating a temporal change in the initial phase of the optical signal due to the phase noise. Therefore, the user of the estimation device 3 can estimate the frequency of vibration and the state of time variation.

Note that, in the removal condition optimization processing, a function represented by the n-th order (n is an integer of 1 or more) term of a Taylor expansion of exp(−jε) may be used as a function approximating the phase variation at the vibration position. The 0-th order term of the Taylor expansion of exp(−jε) is 1. Accordingly, the value of the 0-th order term of the Taylor expansion of exp(−jε) does not depend on the value of ε. Therefore, since the function that approximates the phase variation at the vibration position is a function obtained by excluding the 0-th order term of the Taylor expansion of exp(−jε), the control unit 31 can extract only the effect of changes in ε, and can estimate the phase with higher accuracy. Therefore, the function that approximates the phase variation at the vibration position may be, for example, (−jε).

The signal similarity may be expressed by any index as long as the similarity between the result of the inverse mapping of the propagation mapping acting on the result of the wavelength dispersion reapplication processing and the result of the transmission signal estimation processing is expressed.

Therefore, for example, the processing target of the wavelength dispersion reapplication processing may be the execution result of step S201 and the result of not executing each compensation of step S202 (hereinafter referred to as a “first result”). In such a case, the signal similarity may be, for example, a similarity between a result obtained by applying the polarization variation, the frequency offset, and the carrier phase to the result of the transmission signal estimation processing and the first result. Note that each amount applied is the same as the amount of compensation that would be obtained if compensated. The processing of applying the polarization variation, the frequency offset, and the carrier phase to the result of the transmission signal estimation processing is executed by the control unit 31, for example.

The processing target of the wavelength dispersion reapplication processing may be the execution result of step S201 and the result of not executing the compensation of the polarization variation among the compensations of step S202 (hereinafter referred to as a “second result”). In such a case, the signal similarity may be, for example, a similarity between a result obtained by applying the polarization variation to the result of the transmission signal estimation processing and the second result. Note that each amount applied is the same as the amount of compensation that would be obtained if compensated. The processing of applying the polarization variation to the result of the transmission signal estimation processing is executed by the control unit 31, for example.

The processing target of the wavelength dispersion reapplication processing may be the execution result of step S201 and the result of not executing the compensation of the frequency offset among the compensations of step S202 (hereinafter referred to as a “third result”). In such a case, the signal similarity may be, for example, a similarity between a result obtained by applying the frequency offset to the result of the transmission signal estimation processing and the third result. Note that each amount applied is the same as the amount of compensation that would be obtained if compensated. The processing of applying the frequency offset to the result of the transmission signal estimation processing is executed by the control unit 31, for example.

The processing target of the wavelength dispersion reapplication processing may be the execution result of step S201 and the result of not executing the compensation of the carrier phase among the compensations of step S202 (hereinafter referred to as a “fourth result”). In such a case, the signal similarity may be, for example, a similarity between a result obtained by applying the carrier phase to the result of the transmission signal estimation processing and the fourth result. Note that each amount applied is the same as the amount of compensation that would be obtained if compensated. The processing of applying the carrier phase to the result of the transmission signal estimation processing is executed by the control unit 31, for example.

The processing target of the wavelength dispersion reapplication processing may be the execution result of step S201 and the result of not executing the compensations of the polarization variation and the frequency offset among the compensations of step S202 (hereinafter referred to as a “fifth result”). In such a case, the signal similarity may be, for example, a similarity between a result obtained by applying the polarization variation and the frequency offset to the result of the transmission signal estimation processing and the fifth result. Note that each amount applied is the same as the amount of compensation that would be obtained if compensated. The processing of applying the polarization variation and the frequency offset to the result of the transmission signal estimation processing is executed by the control unit 31, for example.

The processing target of the wavelength dispersion reapplication processing may be the execution result of step S201 and the result of not executing the compensations of the frequency offset and the carrier phase among the compensations of step S202 (hereinafter referred to as a “sixth result”). In such a case, the signal similarity may be, for example, a similarity between a result obtained by applying the frequency offset and the carrier phase to the result of the transmission signal estimation processing and the sixth result. Note that each amount applied is the same as the amount of compensation that would be obtained if compensated. The processing of applying the frequency offset and the carrier phase to the result of the transmission signal estimation processing is executed by the control unit 31, for example.

The processing target of the wavelength dispersion reapplication processing may be the execution result of step S201 and the result of not executing the compensations of the carrier phase and the polarization variation among the compensations of step S202 (hereinafter referred to as a “seventh result”). In such a case, the signal similarity may be, for example, a similarity between a result obtained by applying the carrier phase and the polarization variation to the result of the transmission signal estimation processing and the seventh result. Note that each amount applied is the same as the amount of compensation that would be obtained if compensated. The processing of applying the carrier phase and the polarization variation to the result of the transmission signal estimation processing is executed by the control unit 31, for example.

Note that the signal similarity may be evaluated based on the similarity between the amplitudes of two signals.

Note that the estimation device 3 may be implemented by using a plurality of information processing devices that is communicably connected via a network. In this case, each functional unit included in the estimation device 3 may be implemented in a distributed manner in the plurality of information processing devices.

Note that all or some of the functions of the estimation device 3 may be implemented by using hardware such as an application specific integrated circuit (ASIC), a programmable logic device (PLD), or a field programmable gate array (FPGA). The programs may be recorded in a computer-readable recording medium. The computer-readable recording medium is, for example, a portable medium such as a flexible disk, a magneto-optical disk, a ROM, or a CD-ROM, or a storage device such as a hard disk built in a computer system. The programs may be transmitted via an electrical communication line.

Although the embodiment of this invention has been described in detail with reference to the drawings, specific configurations are not limited to the embodiment, and include design and the like within the scope of this invention without departing from the gist of this invention.

### REFERENCE SIGNS LIST

100 Estimation system
1 Optical fiber
2 Transmitter
3 Estimation device
31 Control unit
32 Receiver
33 Storage unit
34 Input/output interface
91 Processor
92 Memory

1. An estimation device comprising:
a processor;
a storage medium having computer program instructions stored thereon, wherein the computer program instruction, when executed by the processor, perform processing of:
estimating a vibration position that is a position on an optical fiber where vibration is induced by vibration of an external environment based on a reception signal that is a result of propagation of a transmission signal that is an optical signal transmitted by a transmitter through the optical fiber, wherein
estimation processing is executed, including:
compensation processing including wavelength dispersion compensation processing of compensating for wavelength dispersion with respect to the reception signal,
transmission signal estimation processing of estimating the transmission signal based on a result of the wavelength dispersion compensation processing,
wavelength dispersion reapplication processing of reapplying the wavelength dispersion to a result of the compensation processing, and
vibration position estimation processing of estimating the vibration position based on a result of inverse mapping of mapping according to the vibration position, the mapping representing a change in the transmission signal due to propagation through the optical fiber, acting on a result of the wavelength dispersion reapplication processing and a result of the transmission signal estimation processing.

2. The estimation device according to claim 1, wherein
in the vibration position estimation processing, a position having a highest level of similarity between a result of the inverse mapping acting on the result of the wavelength dispersion reapplication processing and the result of the transmission signal estimation processing is estimated as the vibration position.

3. The estimation device according to claim 1, wherein
the processor executes the estimation processing on a plurality of reception signals having different timings of propagation through the optical fiber.

4. The estimation device according to claim 1, wherein
the vibration position estimation processing executes, for one or a plurality of candidates for the vibration position, removal condition optimization processing of estimating a condition for most removing phase noise at the vibration position based on the result of the inverse mapping acting on the result of the wavelength dispersion reapplication processing and the result of the transmission signal estimation processing.

5. The estimation device according to claim 4, wherein
in estimation of the condition, a value of phase variation at the vibration position is estimated.

6. The estimation device according to claim 4, wherein
in the removal condition optimization processing, a function represented by the n-th order (n is an integer of 1 or more) term of a Taylor expansion of exp(−jε) is used as a function approximating a phase variation at the vibration position.

7. An estimation method comprising:
estimating a vibration position that is a position on an optical fiber where vibration is induced by vibration of an external environment based on a reception signal that is a result of propagation of a transmission signal that is an optical signal transmitted by a transmitter through the optical fiber, wherein
estimation processing is executed, including:
compensation processing including wavelength dispersion compensation processing of compensating for wavelength dispersion with respect to the reception signal,
transmission signal estimation processing of estimating the transmission signal based on a result of the wavelength dispersion compensation processing,
wavelength dispersion reapplication processing of reapplying the wavelength dispersion to a result of the compensation processing, and
vibration position estimation processing of estimating the vibration position based on a result of inverse mapping of mapping according to the vibration position, the mapping representing a change in the transmission signal due to propagation through the optical fiber, acting on a result of the wavelength dispersion reapplication processing and a result of the transmission signal estimation processing.

8. A non-transitory computer readable medium which stores a program for causing a computer to function as the estimation device according to claim 1.
